(19) United States
(12) Patent Application Publication
(10) Pub. No.: US 2020/0320895 A1
(43) Pub. Date: Oct. 8, 2020

(54) COMPUTERIZED ENTERTAINMENT SYSTEM FOR PROVIDING MULTIMEDIA ACTIVITIES TO YOUNG CHILDREN

(71) Applicant: Dan Dan YANG, Ottawa (CA)

(72) Inventor: Dan Dan YANG, Ottawa (CA)

(21) Appl. No.: 16/908,380

(22) Filed: Jun. 22, 2020

Related U.S. Application Data
(63) Continuation-in-part of application No. 15/224,106, filed on Jul. 29, 2016.
Application No. 15/224,106 is a continuation-in-part of application No. 13/684,424, filed on Nov. 23, 2012, now abandoned.

(51) Int. Cl. G09B 7/00; G09B 19/00

(52) U.S. Cl. CPC G09B 7/00; G09B 19/025; G09B 19/00

(57) ABSTRACT

Systems, methods, and devices for providing multimedia-based entertainment activities to be provided to a user that is under the age of 60 months. These activities may be based on each user's profile. Multimedia-based activities are highlighted and are presented to the user using, preferably, hand held, touch screen enabled devices. Data for the multimedia-based entertainment activities may be stored on the device or on remote servers with the data being downloaded as necessary.

### RELATED APPLICATIONS

This application is a Continuation in Part of U.S. application Ser. No. 15/224,106, filed Jul. 29, 2016, which is a Continuation in Part of U.S. application Ser. No. 13/684,424 filed Nov. 23, 2012.

### TECHNICAL FIELD

The present invention relates to entertainment systems. More specifically, the present invention relates to systems, methods, and devices which provide automatic multimedia activities for children.

### BACKGROUND

The increasing encroachment of digitization and computers into the daily life of the 21st century is well-known. Computers and digital data are increasingly replacing the analog world of pen, paper, and printed materials. This steady encroachment has not spared the entertainment world as computers, digital devices, tablets, and other computing devices are increasingly being used for entertainment purposes everywhere. The rise of the tablet computing devices as well as the smartphone ushers in a new era of user centric computing. Everywhere, these devices provide quite a few advantages—they deliver a large amount of materials to the fingertips of users, thereby making activities based on the materials to be fun and interactive while their size and weight make them very accessible to younger users.

However, none of the presently available desktop computers, tablets, or user computing devices do more than deliver activity based materials. In other words, none of the existing computing devices provide opportunities where users not only access computing device based materials in order to gain new knowledge, but which also collect and analyze a user's associated data to arrive at that user's profile. Such a profile can be used to gain insight into the user's actual mental process so that more personalized activity materials can be automatically presented to the user. As well, none of the current systems assess each user based on the performance of other users. Such an analysis can reveal whether a specific user is progressing at the same pace as the other users or whether that specific user is lagging behind the others.

From the above, it should be clear that no current systems or applications allow caregivers to quantify each user's progress and capabilities. As an example, it is fairly common to hear people, whether it is the parent or the student himself note that 6-year Johnny is “not good at counting”. However, neither Johnny nor the parents can tell the exact area in which Johnny is failing. Did Johnny get the wrong result because Johnny has issues with sequential order or did Johnny get the wrong result because he counts some numbers more than once?

Similarly, no current systems or applications base their recommendations on the user's user profile. Current systems are not stand alone systems which analyze, present, and assess each user based on that user's continuing progress.

It should be noted that no existing systems target very young children who may have fallen behind or who are falling behind their peers or behind other children of a similar age or background. Issues with specific subjects or with physical, speech, or coordination based skills may be hard to detect at a young age and may lead to other, more problematic issues. Should such issues continue, they may lead to problems with self-esteem, problems in school, or behavioural issues. As such, it would be greatly advantageous if such issues can be caught and addressed at an early age.

Based on the above, there is therefore a need for systems and methods which allow for the use of computing devices, including desktops and/or portable computing devices, to assist a user's abilities by delivering activity based materials while, at the same time, gathering a user's performance data so that this data can be analyzed. Once analyzed, they can be used to provide individualised and targeted materials specific to each user's issues with abilities during the process. Preferably, such a system would analyze and address each user's progress status, weaknesses, strengths, and progress with appropriate materials being mapped to each user's capabilities.

### SUMMARY

The present invention provides systems, methods, and devices for providing entertainment activities to be provided to a user that is under the age of 60 months. These activities may be based on each user's profile. Multimedia-based activities are highlighted and are presented to the user using, preferably, hand held, touch screen enabled devices. Data for the multimedia-based entertainment activities may be stored on the device or on remote servers with the data being downloaded as necessary.

The present invention may also be used for providing a diagnosis structure which quantifies each user's profile and provides relevant activities based on each user's profile. As well, an analysis of the user's progress relative to a comparable group of users is provided. Should the user be lagging behind the performance of the comparable group, suitable activities are selected and presented to the user to bolster the user's performance. Included are analyses of the areas in which the user is lagging, and the provision of material which have been mapped to a user's specific profile and progress.

In addition to the above, the present invention can also be used in a multi-faceted approach to diagnosing and determining root causes of a specific child's problems including physical issues and developmental issues.

The present invention can be part of a multi-faceted, personal approach to diagnosing child issues with physical, mental, and potentially psychological problems. A child's performance issues in school may be traced to earlier issues with skills and abilities that were either undeveloped or insufficiently developed. As these skills or abilities languished, other skills and abilities, which may depend on the earlier skills, similarly remain undeveloped or underdeveloped. As an example, a child might not have developed suitable reading skills for his or her age may have an issue with recognizing the shapes of letters and this issue may be traceable to his or her infancy. The database of a child's performances when interacting with the present invention can provide a wealth of knowledge for someone diagnosing or trying to determine the roots of a child's issues. The results of each interaction that a child has with the present invention allow for the gathering of data that provides a more complete picture of the child's developmental process. These results in various areas can be mapped and extrapolated to determine future potential issues and to determine remedial actions to avoid or mitigate these future potential issues.

The present invention can thus be part of a system that measures and analyzes a child's developmental status in a multi-faceted way. A child's developmental status can be measured using content that is fun to a child, including games and similar activities. As part of the system, questions directed to the child's caregivers can be used to gather and assess data relating to various areas including the child's motor skills, language skills, cognitive/logic reasoning skills, social-emotional skills. This data provides a holistic view of each child's development in multiple interlocking and interrelating areas. Unlike traditional/existing systems, the data gathered not only indicates if a child can or cannot perform a task, but, by using data gathered from different interrelated area, can also provide potential reasons for the child's performance or lack thereof.

In the present invention, computing devices are networked and configured for delivery of activity related material, data gathering, analysis and reporting as well as delivering in real time materials based on the analysis of the data gathered.

These computing devices include user computing devices, caregiver/assistant computing devices, and data hosting/analysis computer servers. For home use, typically these computer devices can be combined into one desktop or laptop computer. For non-home use, these computers may include a user's computer or tablet computer, an assistant's computer or tablet computer, and a remote server. Other options are, of course, possible. These computing devices may be in the form of automated teaching assistants, devices programmed with automated avatars, and/or surrogate automated teachers.

The user computing devices serve to receive materials, to gather each user's performance data into an individual user performance database every time the user uses activity related material, and to upload the user's performance data to a cumulative user performance database housed on a data server. In one implementation, the activity related material has predetermined cumulative target milestones and the user's progress in achieving these milestones while using the activity related material can be data mined. Each user's progress can thus be mapped to the milestone achievement database. Similarly, each user's progress can be compared to a comparable user group's progress or performance.

User data for each individual user can be provided in a report format for storage in the individual user performance database as well as in the cumulative user performance database. This user data can be used as the basis for automatically selecting and providing activity related materials that are standard or individualized based on the user's progress. Based on the progress of the user relative to the progress of the comparable user group, specific activities are provided to the user to either advance the user or for the user to catch up to the group's performance level.

A computer server performs the function of collecting performance data gathered from each user computing device. The server aggregates this collected data into a cumulative user performance database stored on the server. Data analysis on each user's performance data, including mapping the user performance data to the targeted milestones may be performed by the server or by the user computing device.

It should be noted that, in addition to the individual user performance database and the cumulative user performance database, an activity database, housed partially by the server and partially by the user computing device, is also used. The activity database includes modules for execution by the user computing device. When executed, these modules provide users with activities for instructing or reinforcing skills relating to one or more subjects.

In a first aspect, the present invention provides a system for delivering activity content to a user, the system comprising a server, multiple databases, and a user computing device. One of the databases, a cumulative user performance database on said server, is for storing results of attempts at completion of activities by said user and other users. This cumulative user performance database is updated after every attempt at completion of an activity by said user.

In another aspect, the present invention provides a system for delivering entertainment content to a user, the system comprising:
a user computing device, said user computing devices being for use said user, said user computing device determining a multimedia-based activity to be presented to said user;
an activity database storing multimedia data related to a plurality of digital entertainment activities, said data being retrieved by said user computing device to present to said user, said multimedia-based activity being presented to said user using said multimedia data retrieved from said activity database;
   wherein
said user is a child of under 60 months in age.

For this system, the user computing device is for use said user and is in communication with said server. This at least one user computing device determines an activity to be presented to said user.

Another database used in the system is an individual user performance database resident on said user computing device. This individual user performance database is for tracking a progress of said user and is updated with said user's performance whenever said user interacts with an activity on said user computing device. The individual user performance database stores at least one performance metric for said user for at least one activity accessed through said at least one user computing device.

A third database used by the system is an activity database storing a plurality of digital activities for presentation to said user by way of said user computing device. The user computing device automatically selects at least one activity from said activity database.

The system operates with the user computing device communicating with said server to retrieve performance data relating to at least one skill or subject from said cumulative user performance database for other users who are comparable to said user in at least one general profile characteristic. The user computing device retrieves said user's performance relating to said at least one skill or subject from said individual user performance database. Once the data has been retrieved, the user computing device performs a comparison of said performance data from said cumulative user performance database with performance data for said user from said individual user performance database to determine which activity to present to said user.

Note that, after every interaction by said user with an activity on said user computing device, said user computing device uploads to said server results of said interaction to thereby update said cumulative user performance database. The system operates well when the user is a child of under 60 months in age.

In addition to the above databases, the system can include a reference database containing a complete list of achievement milestones and sub-milestones with age and level references. These milestones, of course, relate to the various activities contained in the activity database. The collected data from the user are compared with these milestones. The system also includes a user specific database containing data collected from the user, the data collection occurring whenever the user uses specific activity related material that contains pre-determined achievement milestone targets. This user specific database has a specific user profile which contains user achievement records based on the target milestones. For this system, the user computing device delivers the activity to the user, the user computing device gathers data regarding the performance of the user in the activity and sends the data as a database entry to at least one of the databases.

At least one database entry stored by the user performance databases and originating from the user computing device details: an activity through a specific activity related material, an identity of the user which may include user's name, age, and a result or results of the activity for the user.

In one implementation, each activity relates to at least one milestone and data collected for one of the user databases includes data on said user and which milestones have been achieved by said user. As well, each database entry collected by said user database and originating from said user computing device details an activity and at least one result of said activity for said user. The database entry stored in a database may include the results of an analysis of the user's performance in the activity when compared to the reference database which contains the target achievement milestones. The database entry may also include the user's achievements relative to the entries in the reference database. Thus, if a user fails at an activity or performs better than expected at an activity, the user's performance is compared with other milestones that may be surpassed or achieved by the user's performance. A user can therefore “jump” ahead by achieving milestones that may otherwise not be attainable by a better than expected result. Similarly, if a user fails at an activity, the user may not achieve the milestone at which the activity is aimed at but a lower level milestone or a different milestone may be achieved.

### BRIEF DESCRIPTION OF THE DRAWINGS

The embodiments of the present invention will now be described by reference to the following figures, in which identical reference numerals in different figures indicate identical elements and in which:

FIG. 1 is a block diagram of a system according to one aspect of the invention; and

FIGS. 2 and 2A are examples of plots of the progress of different user compared to a group's progress; and

FIG. 3 is a flowchart detailing the steps in a method according to another aspect of the invention.

### DETAILED DESCRIPTION

Within this document, it should be understood that the term “user” encompasses a young person who is in the process of performing an activity or interacting with a device in an activity. This includes children who might be performing the activity on their own or who may be coached or assisted by an older assistant. The term “assistant” or “caregiver”, in this document, includes any person or group of persons who may be instructing or who are assisting in the care or instruction of a user. Thus, a user may be a child at home performing a computing device based activity on their own (or guided by an older relative or a tutor) or a student in a classroom being taught by an instructor in a traditionally structured environment. Similarly, a caregiver or assistant may be a parent assisting their child, an instructor in a classroom setting, a tutor with one or more pupils, or any other person who may be involved in instructing or otherwise guiding a young person. Preferably, the user is a child who is 5 years of age or younger. It should be clear that the system of the present invention may be used to deliver entertainment content to the user using multimedia-based activities.

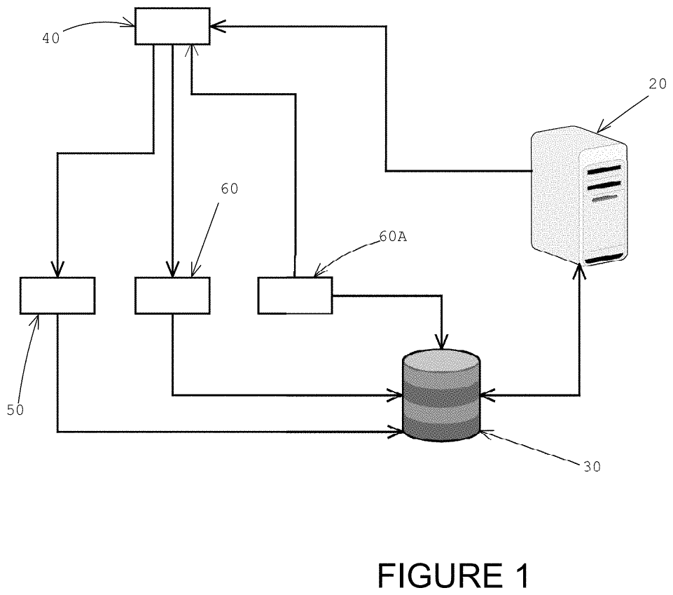

Referring to FIG. 1, a block diagram of a system according to one aspect of the invention is illustrated. In the system 10, a server 20 operates to store, update, and maintain a cumulative user performance database 30. A user computing device 40 is in communication (preferably wirelessly) with the server 20. Resident in the device 40 is an individual user performance database 50. The individual user performance database 50 is updated whenever the user uses the device 40 for an activity provided by the system 10. Also part of the device 40 is an activity database 60 that contains modules for various activities available to the user by way of the device 40. It should be noted that, in some implementations of the present invention, another part of the activity database 60A is resident on the server 20. The device 40 can, if necessary, download more activities and modules for presenting these activities from the server 20.

The system 10 operates with the user using the device 40 to participate/complete an activity presented by the device 40. As will be explained below, the activity can be a game, puzzle, or any other activity accessible by way of the device 40 or the activity may be entertainment related. Every time the user uses the device 40 to complete/participate in an activity provided by the system, the individual user performance database 50 on the device 40 is updated with the user's performance. The activity, the parameters of the activity, the details regarding the activity, the result of the activity (e.g. whether the activity was successfully completed/not completed, how long it took to complete the activity, how many correct/incorrect entries for the activity were made, etc.) and the user's abilities concerned with accomplishing (or not accomplishing) the activity are all documented and stored in the individual user performance database 50. Once stored in the individual user performance database 50, the user performance data for that instance of the user's use of the device 40 is then uploaded to the cumulative user performance database 30. The cumulative user performance database 30 stores the user performance data for all users using various devices 40 which use the system 10. This database 30 allows for the cumulative and continuous gathering of performance data for various users at different ages, stages of development, parental involvement, and capabilities.

The system 10 also operates by way of the user device 40. When the user selects a subject/activity/skill to be learned or developed, the device 40 checks the cumulative user performance database 30 and the individual user performance database 50 to determine how the user is progressing relative to the other users in the database 30 in terms of that specific subject/skill. Thus, the particular user's performance data for that specific subject/skill is compared to the performance of other users who are comparable to the particular user in terms of at least one of: age, ethnicity, socio-economics, demonstrated ability, and other parameters. If this particular user is lagging relative to a comparable group of other users (as evidenced by the group's performance data in the database 30), then the device 40 randomly selects an available activity for that subject/skill appropriate for that particular user's progress. The activity can already be resident on the device 40 or it can be downloaded from the server 20. As long as the check between the particular user's performance data relative to a comparable group's performance data shows that the particular user is lagging behind the group's performance data, then the device 40 will keep presenting that specific activity level or skill appropriate for that particular user. Once the user's performance data shows that the user is at a level that is comparable (i.e. within acceptable limits) to the comparable group's performance level for that skill/subject, then the device 40 can present the user with the next stage or level of activity for that particular skill or subject.

As a concrete example, the cumulative user performance database may show that, within the database, users at age 1 are able to count to the number 5 80-90% of the time (i.e. for every 10 tries, the user at age 1 should be able to count to 5 eight to nine times out of the 10 tries). It should be noted that the performance level in this case is given as a percentage of success rate to account for errors. To account for a lower level of acceptable performance, the system 10 may be configured to accept a 70% success rate as being acceptable. Of course, a success rate higher than that shown by the group is also acceptable. Thus, if a particular user can count to the number 5 with a success rate of 70%, then that user is considered to be performing at about the same level as the comparable group whose data is in the cumulative user performance database. If a particular user is only able to count to 5 six times out of ten, then the device 40 and the system 10 will keep providing that particular user with activities that relate to counting to 5. Once that particular user's performance data has improved to at least 70% success rate, then the device 40 will provide with user with activities that relate to the next related activity, that of counting to 6.

It should also be clear that while the device 40 can compare a particular user's performance data for each skill to be developed or tested to the performance data of a comparable group from the cumulative user performance database, this may also be done on a per subject basis. Thus, as an example, a particular user may be lagging behind the group performance for the skill of counting up to 5 but that particular user may, for the larger subject of math, be at the same level as the comparable group. Since every subject is divided into categories and each category is divided into sub-categories and each sub-category is divided into specific skills, then a particular user may be lagging the group performance in a number of skills but, as a whole, that particular user's performance may be in line with the rest of the group. As an example, if a subject is composed of a number of categories, sub-categories, and skills with a total of 100 skills, if a particular user's performance indicates that, of the 100 skills, his or her skills are in-line with the group performance for 80 skills, then that particular user is progressing at the same rate as the rest of the comparable group. However, of the 20 skills in which the particular user is lagging behind, the system will keep presenting activities relating to those 20 skills to the particular user until he or she is performing at the comparable group's performance level for all the skills.

The system 10 and, particularly the device 40, can be configured to provide the user's parent or caregiver alarms regarding the user's performance level relative to the comparable group. To determine if an alarm is required, the device 40 can use patterning to determine a particular user's performance relative to the group. Thus, if, of the 100 skills in the above example, a particular user is lagging in more than 50 of these skills, the system can generate an alarm to alert the user's parent or caregiver. An email, text message, or similar communication can be sent by the system to the parent or caregiver. Similarly, if a particular user has been lagging behind the group's performance for a significant period of time for a specific skill or skills (e.g. the user is lagging in counting for 3 months), an alarm or alert can be generated. As well, if a user has a particularly low level of performance for a given skill after a predetermined number of tries (e.g. 20 tries at counting to 5 and only a 30% or 40% success rate), the system may generate an alert to the caregiver or parent. Such alerts may recommend that the caregiver or parent seek extra professional help for the user in that particular subject or skill. As can be seen, if the particular user's performance data indicates a pattern of behavior where the user is consistently lagging behind the group's performance, then the user's parent and/or caregiver can be alerted to this pattern. It should be noted that the pattern may be seen as lagging behind the group performance in a single subject, in multiple skills in multiple subjects, or lagging behind the group performance over a predetermined period of time.

As noted above, the device 40 can present the user with an activity related to the subject or skill that needs to be taught or developed. To accomplish this, each available activity is tagged with one or more tags, each tag relating to the skill, subject, category, or sub-category to which the activity relates to. As an example, an activity where the user has to identify 3 dogs and 4 cats in a picture can be tagged with MATH (for the subject), SCIENCE (another subject), ANIMAL IDENTIFICATION (for a category under science), NUMBER SENSE (for a category under math), COUNTING (as a sub-category under number sense), COUNT TO 3 and COUNT TO 4 (as skills under the sub-category counting), MAMMALS (as a sub-category under animal identification) and DOG and CAT (as skills under the sub-category mammals). With this classification and tagging of multiple activities with multiple tags, a search for activities with a specific tag will result in multiple possible activities. Another activity could involve counting the number of dots (4 dots on one wing and 5 dots on another wing) on a ladybug's wings. Such an activity may have the following tags: MATH, NUMBER SENSE, COUNTING, COUNT TO 4, and COUNT TO 5. To assist in randomly selecting an activity for a specific skill, subject, sub-category, or category, the device 40 aggregates the activities with the relevant tags and generates indices for each of these relevant activities. Then, using a random number generator (or a pseudo-random number generator), the device 40 generates a number. This generated number can then be processed so that it relates to the range of indices generated for the relevant activities. The activity whose index is closest to the generated number (after processing) is then presented to the user as the selected activity. As an example, if a user needs to be presented with an activity relating to counting to 5, the device 40 can aggregate the various activities tagged with the tag COUNTING TO 5 and can generate suitable indices for these activities. If, in one example, 10 activities were tagged with the relevant tag, these activities can be assigned indices 1 to 10. Then, using the random number generator (or a pseudo random number generator), the device 40 can generate a suitable number (e.g. 0.469). This number can then be multiplied by 10 (such that it falls within the range of the 1 to 10 indices). The closest index (i.e. 5) to the processed number (in this example 4.69) is thus the chosen index. Thus, the activity assigned with index 5 is thus presented to the user as the selected activity.

As noted above, while some activities can be stored on the device 40, others can be downloaded from the server. To prevent having to generate multiple indices every time an activity is required, indices for various skills, subjects, categories, and sub-categories can be generated once for the activity database stored on the device 40 and these indices can be stored on the device. Thus, if an activity relating to the skill of identifying world landmarks is required, then the index list for that specific skill can be retrieved and a random number can be generated to determine which activity is to be presented to the user. Similarly, if a user is lagging in the subject of science and a science related activity is required, then the index list for activities tagged with the science tag can be retrieved and an activity can be selected using the process outlined above. However, once one or more activities are downloaded from the server, new indices may need to be generated as the activity database stored on the device 40 has changed. These new indices would need to take into account the newly downloaded activities from the server.

It should, of course, be clear that since each activity may have multiple tags and be associated with multiple categories, skills, sub-categories, and subject, every time a user attempts or completes an activity, this generates multiple sets of data for different subjects, skills, and categories. Thus, if a user completes the activity noted above of identifying 3 dogs and 4 cats in a picture, then this generates data for the math subject, the count to 4 and count to 5 skills, the science subject, the identifying dogs and identifying cats skills. Since the user has successfully completed the activity, then this instance counts as a successful attempt for all of those various skills and would improve the user's performance data.

As will be discussed in more detail below, the device 40 can automatically set parameters for each activity presented to the user. Depending on the user's progress for a specific skill, the device 40 may adjust the parameters of an activity to make the activity harder or easier to accomplish. This, if the user is having issues with counting to 5, the parameters for the activity may give the user more time to finish the task. Or, conversely, if the user does not have any problems counting to 5 (e.g. he has succeeded 7 times out of 10), then the activity may be configured to give the user less time and less chances to complete the activity.

For clarity, the subjects, categories, sub-categories, and skills may be different in different implementations. In one implementation, for the subject MATH, two of the subcategories and skills under the category number sense may be as follows:

Subject: Math

category: number sense
subcategory: counting
   skill—count to 3
   skill—count to 4
   skill—count to 5
subcategory: differentiation between numbers
   skill—differentiate between 3 and 4
   skill—differentiate between 1 and 2
   skill—differentiate between 2 and 3

For greater clarity it should be clear that a user's performance may be determined using many rubrics. As examples, whether the user completes the activity may be one measure of performance, how long it took the user to complete the task may be another measure of performance, how many successes the user has had as a percentage of attempts at completing the activity may be another measure of performance. Similarly, the number of milestones completed or which milestones have been completed might be another measure of performance. Regarding milestones, the cumulative user performance database may indicate that, at the age of x months of age, a user should have completed milestones a, b, and c. If a particular user has not yet completed or achieved milestones a, b, or c at the age of x months, then that particular user is underperforming relative to the users in the cumulative user performance database. Thus, instead of a measure of a quantity by which a specific user is underperforming (or lagging) relative to the comparable group (e.g. user A only achieves counting to 5 60% of the time versus a group statistic of counting to 5 80% of the time), a milestone based performance determination would only indicate whether a particular user has achieved or not the same milestones as the comparable group. If the group has achieved more specific milestones than the particular user at a particular age, then that user is lagging or underperforming.

It should also be clear that the cumulative user performance database and the individual user performance database will have different contents. The individual user performance database will be resident on the user device and is for tracking, managing, and determining an individual user's progress. As such, this individual user performance database will have detailed entries for each time that particular user uses the device and interacts with, completes, or attempts an activity presented by the device. The individual user performance database will track each activity, each skill, each subject, each category, and each sub-category for that particular user. The number of times a skill is tested, the number of times a particular activity is attempted, the success or failure of those attempts, the number of times a particular action is attempted in an activity (e.g. manually touching a dot on a multi-dot image), errors made by the user, the types of errors made by the user, and even the reasons for these errors are tracked by the individual user performance database. The contents of the individual user performance database is suitable for building a very detailed user profile including that user's strengths, weaknesses, mental or computational capabilities, and skills.

In contrast to the above, the cumulative user performance database merely tracks the end result of activities for available users. Thus, as an example, if 100 users are using devices in communication with the server, with 30 of those users being 1 year of age and female, then a female 1 year old user will have her performance compared against those 30 users whose activity performance will be stored in the cumulative user performance database. Thus, if the majority of those 30 users are able to count to 5 (as a skill) 80% of the time, then that particular 1 year old female user should also be able to count to 5 at least 80% of the time. Every time one of the members of this group of 30 female 1 year old users attempts an activity which is tagged with the skill of counting to 5, the result of that attempt is documented and uploaded to the cumulative user performance database. The result of each attempt at an activity by a user is documented, along with the various skills, subjects, categories, and sub-categories associated with that activity, and that result and activity and tags are all uploaded and incorporated into the cumulative user performance database. Of course, the user's age, gender, and other relevant data points regarding the user are also uploaded and associated with the activity attempt and result. It should be clear that, depending on the implementation, the identity of the user need not be stored on the cumulative user performance database. Preferably, the cumulative user performer database has enough data to determine the skills, abilities, and capabilities of a user of a specific age, gender, and general profile. However, the cumulative user performance database should not have data that can be used to pinpoint the skills and abilities of a specific user.

For a milestone based implementation of the system, the cumulative user performance database can store the results of attempts at specific milestones for the various users. As with the explanation above, the cumulative user performance database receives data from the various devices concerning the end result of attempts at activities by the various users. Instead of a percentage of success for a specific skill, the cumulative user performance database can store which milestones have been achieved by users of a specific age, gender, or general profile. As an example, the cumulative user performance database contents can indicate that 80% of male 20 month old users in the system have achieved the milestone of identifying dogs. A male 20 month old user should therefore also be able to achieve the same milestone. It should be quite clear that a user's user device only downloads the relevant data from the cumulative user performance database or data that relates to the specific user's age, gender, and general profile. Thus, the device being used by an 18 month old female user would not download data relating to 24 month old male users from the cumulative user performance database.

It should be noted that the data in the cumulative user performance database and in the individual user performance database can be used to forecast potential issues with specific users. The data in the cumulative user performance database can be plotted alongside the data from the individual user performance database. These two data sets can then be compared and forecasts can be made regarding an individual user's potential future. To mitigate or even prevent potentially negative future consequences for a user, remedial actions can be taken once projections about a user's progress are made.

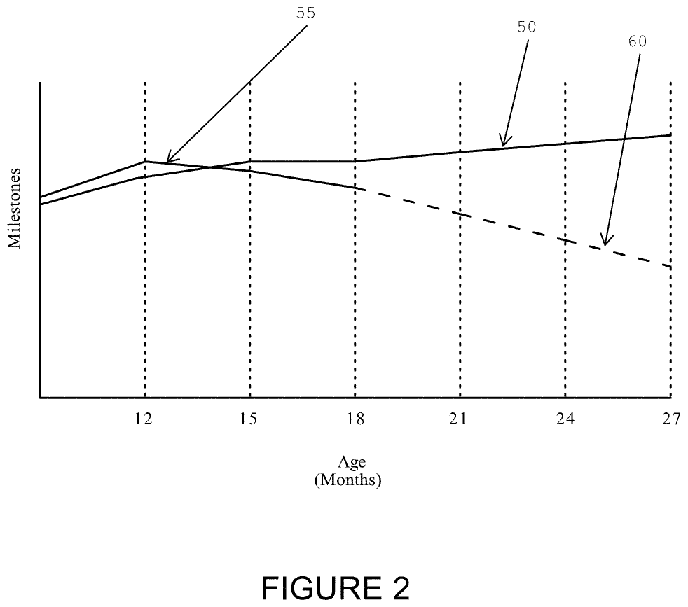

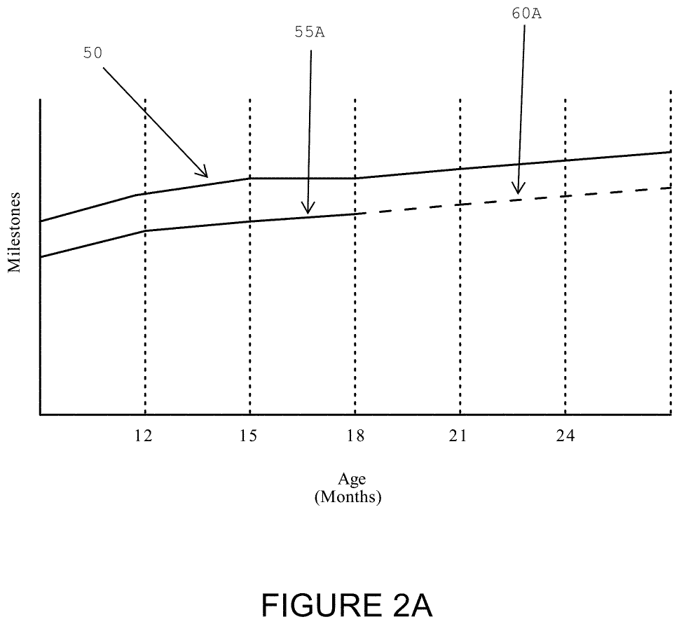

To explain the above, FIGS. 2 and 2A are provided. In these plots, the number of milestones achieved is plotted against a user's age in months. As can be seen, the plot in FIG. 2 plots the number of milestones achieved by the group at specific ages from the cumulative user performance database using a curve 50. Another curve 55 plots the number of milestones achieved by a specific user at the same specific ages. It can be seen that, at 12 months of age, the specific user is outperforming the group as the user has achieved more milestones. However, at the age of 15 months, the specific user is underperforming relative to the group and that this underperformance continues at age 18 months. The system extrapolates from this data (see section 60 in FIG. 2) and shows that, if the decline is not slowed or reversed, by the time the specific user reaches 24-27 months, he or she will be severely underperforming relative to the group. The system can automatically plot the user's performance for a given time period and extrapolate the user's future performance based on the user's previous performance data. Based on the configuration of the system, alerts can be sent to the user's caregiver once data extrapolation indicates that the user is in danger of being left behind or of severely underperforming relative to the group. The system can generate the plots every few months and send such plots to the user's caregiver along with recommendations, suggestions, and alerts regarding the user's performance. The system can be configured to determine a difference between the group performance and a projected performance of the user and, if the difference is greater than a preset metric, the system can generate and alert and recommend remedial action.

It should, however, be noted that underperformance relative to the group may not necessarily cause alarms to be generated. Referring to FIG. 2A, another plot using the same data for the group is presented with data for another specific user. As can be seen, the group's performance data in curve 50 is the same as that in FIG. 2. However, curve 55A is for another specific user and it can be seen that this specific user is slightly underperforming relative to the group. FIG. 2A also shows that the specific user's performance is consistent and that the extrapolated or projected user performance (see curve 60A) actually tracks the trajectory of the group's performance. While the user may not achieve the same number of milestones as the group, this consistency in performance and in performance trajectory may indicate that the user is not in danger of severely underperforming. Of course, the system may still generate these performance plots and performance plot extrapolations and present these to the user's caregiver.

While the system may automatically project a user's future performance based on that user's historical past performance, the plots generated may also be used in conjunction with suitable advice and counselling from qualified counsellors to properly plan any future actions relating to the user. Of course, such actions may include remedial steps to mitigate if not reverse any potential future underperformance by the user.

Each user computing device may take the form of a tablet computing device, a smartphone, a computer notebook, a netbook, or any other device which may be used for data processing. Preferably, the user computing device is portable. The user computing device should, preferably, be able to communicate wirelessly with the cumulative user performance database and/or the server as well as with any other wireless computing device or network.

In one configuration, each user computing device is used by a single user. For this configuration, each user is provided with a profile on the cumulative user performance database server so that each user's performance for activities can be stored, tracked, and analyzed. As noted above, each user's performance is also tracked and analyzed on the device's individual user performance database.

For ease of use by users, it is preferred that the user computing device be equipped with not just a graphical user interface but with a touch screen based GUI. As well, it is highly preferred that the device be equipped with a voice capable user interface. For younger users, each activity may provide voice instructions to the user on how to conduct/complete the activity. This removes the need for users to read on-screen instructions.

The server can be any suitable desktop, laptop, or other type or form of computing device which can communicate wirelessly with the various user computing devices. Of course, such a server should also have the capability to operate, store, update, and manage the cumulative user performance database as well as the activity database.

The cumulative user performance database can be resident on the server or it can be resident on another server at another location. As noted above, the cumulative user performance database receives performance data from the various user computing devices being used by the various users. The data on the cumulative user performance database can be mined and retrieved by the various user computing devices to determine if the user using the user computing device is performing in line with their comparable groups. As can be imagined, a device being used by a 24 month old user would need data for other 24 month old users from the cumulative user performance database while a device being used by a 36 month old user would need performance data for other 36 month old users.

The various components of the system illustrated in FIG. 1 can communicate with one another wirelessly. The different components (i.e. the various user computing devices as well as the various databases on the server) can be wirelessly networked to each other using a wireless network which uses well-known wireless network protocols. Communications between the various components can be effected by using specific modules tasked with dealing with a specific component. As an example, the user devices may be equipped with a module for dealing with the packaging and transmission of user performance data to the server for storage in the cumulative user performance database. Similarly, the same device can also be equipped with a module for receiving processed data from the server and for processing that data for use in determining which activity to present to the user. As well, the same device can be equipped with a module to receive other modules which would be able to present other activities to the user. Thus, each user computing device can be equipped with a module for sending performance results or performance data to the cumulative user performance database and another module for receiving data and activity modules from the server.

For ease of implementation, the various user computing devices, server(s), and the various databases can all be connected or communicating with one another using the Internet. The cumulative user performance database may be physically housed in different servers but logically located as if it was on a single server and be accessible to the various devices and servers through the Internet. The cumulative user performance database may also comprise multiple databases containing different data sets and data types as will be explained below. Instead of a unitary database, the cumulative user performance database may be separated into discrete portions, each containing different datasets for different localities or for different groups or sets of users or for use in different aspects of the present invention and for use in different manners by these different aspects of the present invention.

It should be noted that the activity that each user engages in using the user computing device can be any suitable digital device based activity. Activities that are based around simpler tasks such as counting, identifying specific animals or icons, and the like are suitable for this invention. Of course, more complex tasks such as spelling, difference recognition, arithmetic-based activities, and other activities may also be used. Preferably, the activities selected for the present invention involve the user selecting his or her answers from a range of possible answers with the user indicating his or her choice by touching the selected answer or answers. The user can be presented with the activity and then be given a range of potential answers. The user can then touch selected answer or answers from the options given on the touch screen interface. If the selected answer or answers are incorrect, then the activity can iterate a number of times to provide the user with multiple opportunities to select the correct answers. To assist the user, each iteration (after the first) may have fewer potential answers than the immediately preceding iteration. This provides the user with fewer options and, thus, a greater chance at selecting the correct answer or answers. Part of the parameters sent by the educator computing device to the user computing devices may be the number of iterations allowed, the type of changes in the activity for each iteration (e.g. are the number of options to be decreased/is the number to be counted to be changed), how many options are to be given for each iteration, and the amount of time allowed for the user to complete the activity per iteration (e.g. for the first iteration, the user may be given 45 seconds, for the second iteration, the user may be given 40 seconds, for the third iteration the user may be given 30 seconds, etc., etc.).

From the above, a number of examples can be given to assist in further description. One example relates to a counting-based activity. The user is provided with a picture of a beetle or lady bug with spots on the wing. The user is then prompted to count how many spots or dots are on the lady bug's wings. Based on the configuration, the user either enters how many dots are counted on the wings by selecting from a number of options or the user can individually touch each and every dot on the wing and only after this can the user enter the number of dots counted. In the event the user does not perform a proper count of the dots on the lady bug's wings, subsequent iterations can reduce the number of dots on the lady bug. Conversely, instead of changing the number of dots, the number of dots may stay the same but the numbers provided as options may be changed between iterations. In terms of the user's performance, this can be based on how many iterations were needed to select the correct number of dots. Similarly, further performance can be measured by determining whether the user only activated or touched each dot once.

Another example of an activity which may be used with the system in FIG. 1 relates to spelling. The device may aurally provide a word to be spelled to the user with the user computing devices. The user computing devices may then provide the users with a listing of an alphabet and a number of blank spaces corresponding to the letters of the word that the user was asked to spell. The users can then drag specific letters to the blank spaces. Alternatively, to make the activity easier, instead of presenting the users with a full alphabet, a subset of the alphabet can be presented, thereby limiting the user's options. Or, in another alternative, all the letters which spell out the word can be presented to the user in a jumbled fashion. The user merely has to drag each letter to its proper position in the word blanks to properly complete the activity. A further alternative may show the user some of the letters which form the word. The user merely has to fill in the blanks for the rest of the letters for the word. As part of the parameters set by the device, the parameters may include the amount of time allowed to the user per iteration, the number of extra letters shown to the user, and whether some letters of the word are to be revealed to the user.

Another further example of an activity which may be used for this invention involves the user matching young animals with their parents. For this activity, the user is presented with a number of young animals on one row and a number of adult animals on another row. The user has to pair each young animal with its corresponding adult version (i.e. pair up a child animal with its parent). Performance and progress for the activity can be measured by the user's success rate as well as the number of iterations or attempts before all the young animals are properly paired with their parent.

Once the user has completed the activity or once the time allotted for the activity has passed, the user's performance-related data is gathered at each of the user computing devices. This performance related data is then stored on the user computing devices in the individual user performance database. The result of the activity and the general profile of the user (including the user's age, gender, etc.) can then be transmitted to the cumulative user performance database. As noted above, the performance data may take different forms and may measure different metrics. These forms and metrics may, of course, be dependent on the activity. The data package sent from each user computing device to the server for the cumulative user performance database may include an identification of the user's age/gender, the performance data, an identification of the activity for which the performance data relates, and an identification of the result of the activity. The data package may be sent to the cumulative user performance database using well-known wireless protocols and well-known data transfer techniques.

At the cumulative user performance database, this database receives these database entries using suitable hardware and the data package containing the performance data is received from each user computing device. The data in the data package is then extracted and stored in the cumulative user performance database.

When the device is about to select an activity for a user, the device first determines if the user's performance is in-line with those of a comparable user group. The device communicates with the server and, using the server, the relevant data for a group of users comparable in age (and possibly gender as well as other general profile characteristics) to the specific user is retrieved from the cumulative user performance database and this performance data for the group is analyzed. The analysis may be as simple as determining the group's performance relative to a specific skill, subject, category, or sub-category. Once this analysis has been performed, then the data from the cumulative user performance database can be compared to the specific user's performance data relative to the specific skill, subject, category or sub-category. This comparison is, preferably, performed at the device to avoid having to upload the relevant specific user data to the server. This comparison can thus reveal whether the specific user is outperforming, performs as well as, or underperforms relative to the rest of the group. Depending on the result of the comparison, the device can thus present an activity that is at the level of the group's performance (to bring up the specific user's performance) or at a lower level (to reinforce a basis for a higher level activity).

It should also be noted that the device may perform a more intense analysis of a user's performance, including his or her performance in a variety of activities and with data gathered over a period of time. Such a deeper analysis, when compared with data from the rest of the group of users, can be used to determine how a specific user is performing relative to the group.

The data stored on the device may also be used by the user's instructors or caregivers to determine the user's progress. This data may be viewed using the user's computing device or it may be downloaded and viewed using another device. The manner in which the data is displayed may depend on the configuration of the user computing device (or whatever device was used to access the data) as well as the activity to which the data relates. As an example, if the activity relates to counting items on the screen, the performance data could be presented as scores or bar graphs denoting how many errors each user made, how many iterations were needed before each user to garner a perfect performance, and how long it took each user to count the items. Similarly, if the activity was spelling based, the number of errors made by the various users can be displayed numerically. For the spelling activity, the number of users who spelled the word correctly can be portrayed as a portion of a pie graph. The use of line, bar, or pie graphs can quickly and easily provide the educator or caregiver with a visual indication of the user's success in the various activities.

The individual user performance database noted above and which is used in the invention has a unique structure that allows other applications to take advantage of the benefits of the system.

The individual user performance database has a structure wherein each item is provided with its own table and the columns within that table describe the item. To ensure suitable flexibility in how the system may be used and flexibility in the applications and activities that may use the system, each activity will produce specific database entries for the user using that activity or application. In one implementation, the user's performance is tracked by the database entry produced every time the user uses that activity/game/application. Thus, every time the user uses that game/application, a database entry is generated on the computing device for the individual user performance database. This database entry is then stored in the individual user performance database. A sample format for such a performance data database entry (in an embodiment using milestones) is provided below:

| | | | | | |
|---|---|---|---|---|---|
| | | | Target | | |
| Time | App ID | Milestone ID | Level ID | Result ID | Reason ID |

To explain the various columns in the above database entry, the following table is provided:

| | |
|---|---|
| Time | Time that the data was taken |
| App ID | ID of the application which points to a row |
| | in the Application table which describes the |
| | Application which the user is running |
| Milestone ID | ID of the milestone which points to a row in |
| | the Milestone table which describes the |
| | milestone which is being measured |
| Target Level | ID of the target level which points to a row |
| ID | in the Target Level table which describes |
| | the targeted level of the milestone which is |
| | being measured |
| Result ID | ID of the result which points to a row in |
| | the Result table which describes the result |
| | of the measurement |
| Reason ID | ID of the reason which points to a row in |
| | the Reason table which describes the reason |
| | for the measured result |

As can be seen from the above, each item, whether it is an application, a milestone, a result, or even a reason for the result, is given its own table. In implementations where the device is used by multiple users a separate entry, identifying the user for whom the database entry applies, may be used. Such an entry, e.g. a userID, would be a unique identifier which specifically identifies one specific user.

To further explain the above table and how the various columns and tables provide flexibility for applications and for sorting results, the various items in the columns are described below.

The performance data embodied in the various tables and columns noted above are based on the following performance parameters: Milestones, Target Level, Result, and Reason. The other parameters are provided in the individual user performance database entry to specify the various applications and activities for which the data is for and to allow for easy sorting of the data.

For the Milestone performance parameter, its corresponding Milestone table will have a number of entries which describe the different milestones which are being tested by a game or application or an activity. As an example, if a counting game such as the beetle or lady bug game described above was the activity, one parameter which could be tested would be the user's ability to perform a visual determination (i.e. visually determine the number of dots on the ladybug's wings). For this example, “Visual Assessment” would be an entry in the milestone table. As noted above, a Milestone can be defined as a skill, ability, or capability which is desired to be cultivated, taught, or nurtured in the user. Once the user has shown some facility in this skill, ability, or capability, the milestone can be listed as being achieved. Milestones can be cumulative such that higher level target milestones are only achieved or are only achievable once specific lower level milestones have been achieved. As an example, 3 or 4 specific lower level milestones may be required to have been achieved before a user is provided with an activity for a higher level milestone. It should be noted that the lower level milestones do not necessarily have to relate to the higher level milestone.

For the Target Level parameter, its corresponding Target Level table will have a number of entries, each of which describes a different level of the milestone being tested. To allow for this parameter to applicable to different milestones, the level can be kept generic or general. Continuing the ladybug example game above, when testing the user's ability to perform a visual determination, the application or activity can start by showing a random number of dots. In this example, the Visual Assessment milestone would have various Target Levels, each of which is derived from the number of dots presented to the user. As such, the various entries in the Target Level table could be 2, 3, 4, and 5 as these would be the number of dots presented to the user. In other words, the entries in the Target Level table are what the user should be attempting to achieve to reach the milestone being tested. For the ladybug game, the target levels are the number of dots on the ladybug's wing that the user has to visually determine.

For the Result parameter, the Result table has rows which describe the result which are measured during the testing for the milestone. This parameter is preferably kept generic so that different types of tests and measurements can use the parameter. As an example of how this parameter operates, we can again use the example ladybug game described above. For the ladybug game, when the visual determination milestone is measured, there are only two possible results: a correct or an incorrect visual determination. It should be noted that, for other milestones, the Result parameter may include other possible results.

For the Reason parameter, the corresponding Reason table contains rows which describe the possible reasons for the result which was measured. For the ladybug game example, the visual determination milestone may have reasons would include: “child has counted more items than shown”, “child has counted fewer items than shown” and “child has counted number of items shown”. The entries in the Reason table are therefore the justifications for the results of the performance measurements.

It should be noted that the entries in each of the tables for the above parameters can be re-used by multiple games or applications or activities. It is preferable that the entries in these tables are reused when measuring the same feature to assure that analyses using the data in the database are performed correctly. As an example, two applications may both measure “Visual Assessment”. Both applications will have to store the data under the same milestone ID of “Visual Assessment” and use appropriate Target Level, Result and Reason ID entries. If the use of these parameters is consistent, a query for data for a child's performance on “Visual Assessment” will provide consistent results.

As noted above, each user computing device gathers performance data for each instance a user uses an application or activity. Below is provided a simplified version of a database entry that a user computing device compiles in the individual user performance database.

| | |
|---|---|
| Time | 11:23:44 am |
| App ID | App 1 |
| Milestone ID | Visual Assessment |
| Target Level ID | Count to 3 |
| Result ID | Incorrect |
| Reason ID | child has counted fewer items than shown |

The above individual user performance data database entry was for the ladybug example game previously described. For this example instance, the user was shown 3 dots and the user selects a count of 2. For the next iteration of the activity, the user is shown 2 dots and the user correctly counts 2 dots and correctly enters 2 dots. The resulting database entry generated then becomes:

| | |
|---|---|
| Time | 11:25:44 am |
| App ID | App 1 |
| Milestone ID | Visual Assessment |
| Target Level ID | Count to 2 |
| Result ID | Correct |
| Reason ID | child has counted number of items shown |

The database system also allows for finer granularity in the data such that more detailed searches and data analysis can be performed for an individual user's capabilities. One example of such a capability requires more entries in the milestone table. An added milestone can be titled “Visual Assessment plus Continued Counting” with its own set of data for the Milestone, Test Level, Result and Reason tables. For this set of data, some of the values may overlap with the set of data for the Visual Assessment milestone.

In the above example for Visual Assessment plus Continued Counting, the Target Level can be very specific (e.g. “visual assessment of 4 dots plus continued counting of 3 dots”) or it can be less specific (e.g. “count to 7”). The detail level for the Target Level may depend on the specificity desired for a search and analysis. The data in the individual user performance database can be data mined by the device or by an educator or caregiver to determine what issues the user may be having or what the user's strengths are.

Continuing the above example for Visual Assessment plus Continued Counting, the entries in the Result table can be set to “correct” or “incorrect”. The reasoning for the result achieved can be placed at the Reason table.

For the Reason table for this new milestone, two approaches can be taken: very detailed Reasons can be given or more generic Reasons can be used while categorizing the results. The detailed reasons can describe what the user did and how these actions were correct or incorrect. As examples, these detailed reasons can include: “items on right are touched once and result is correct”, “items on both left and right are touched once and result is correct”, “items on left and right are touched once and result is incorrect”, “items on right are touched once and result is only right items”, “items on right are touched more than once and result is more than the items on the right”, and “items on right are touched once and result is more or less than total number of items”. These entries may, of course, be predetermined and be entered into the individual user performance database upon the detection of specific actions by the user when performing or attempting a specific activity.

Conversely, the less detailed but categorized reasons can include: “child is not visually estimating”, “child is using wrong reference”, “child is skipping numbers”, and “child has counted number of items shown”. Of course, the determination as to when to use which result and which reason is based on the internal logic of the application or activity.

For this new milestone, an application or activity can generate the following database entry for storage in the database:

| | |
|---|---|
| Time | 11:25:44 am |
| App ID | App 1 |
| Milestone ID | Visual Assessment and Continued Counting |
| Target Level ID | Count to 7 |
| Result ID | Correct |
| Reason ID | child has counted number of items shown |

The above database entry was created after the user was presented with 3 dots on a left wing of a ladybug and 4 dots on a right wing of a ladybug in an activity where the user has to determine how many dots are present on the ladybug and to touch or activate some of the dots on the ladybug. For this database entry, the user touched each of the 4 dots on the right wing and was supposed to visually estimate how many dots were on the left wing. The user then selected a total number of 7 dots.

For the next iteration of the example, the user is presented with 5 dots on one wing and 5 dots on the other wing. After the user touches all the dots on one of the wings once and selects a count of 8, the following database entry is produced:

| | |
|---|---|
| Time | 11:26:44 am |
| App ID | App 1 |
| Milestone ID | Visual Assessment and Continued Counting |
| Target Level ID | Count to 10 |
| Result ID | Incorrect |
| Reason ID | child is skipping numbers |

As can be seen, the user correctly counted the dots by touching them. However, the user's incorrect result shows that the user is not keeping proper track of the numbers.

In another example, the user is shown a ladybug with 2 dots on the left wing and 4 dots on the right wing. The user then touches all the dots on both wings and enters a value of 6. This instance of the use of the application results in the following database entry:

| | |
|---|---|
| Time | 11:26:44 am |
| App ID | App 1 |
| Milestone ID | Visual Assessment and Continued Counting |
| Target Level ID | Count to 6 |
| Result ID | Incorrect |
| Reason ID | child is not visually estimating |

As can be seen from the database entry, the user is not visually estimating the number of dots as the user is touching and counting all the dots.

As noted above, the milestones used in the database can be cumulative such that achievement of lower level milestones can lead to the achievement of higher level milestones. As an example, from the above example of counting dots on a lady bug, if the user was originally presented with 3 dots on the ladybug and then is presented with three more dots, if the user only touches the further 3 dots, a table for the milestones and results may be as follows:

| Milestone | Target Level | Result | Reason |
|---|---|---|---|
| 3100-04 - | Count to 6 | Correct | User has counted |
| Point and | | | number of items |
| count | | | shown |
| 3100-05 - | Count to 6 | Correct | User has counted |
| Sequential | | | number of items |
| quantity | | | shown |
| 3120-01 - | Count to 6 | Correct | User has counted |
| Count | | | number of items |
| starting at | | | shown |
| 2, 3, 4, or 5 | | | |
| 4100-01 - | Count to 6 | Correct | User has counted |
| Continued | | | number of items |
| count and | | | shown |
| visual count | | | |

As can be seen from the above, the higher level milestone (continued count and visual count) builds on the lower level milestones. Specifically, the milestone denoted by the code 4100-01 requires the milestone denoted by 3120-01 to work. For clarity, it should be clear that “continued count” cannot operate without the lower level milestone of “count starting at 2, 3, 4, or 5”. Of course, while the above shows that some target milestones may depend on lower level milestones, this is not necessarily the case for all milestones. Some target milestones may require lower level milestones which are not directly related to the target milestone.

To assist an educator or caregiver in determining a user's progress, a report regarding the data processed from the individual user performance database may be generated. In one implementation, the report provides details on the user's progress towards a specific target milestone. In another implementation, the report provides details for the user's progress relative to the progress of a comparable group of other users. As an example, the report can detail how many milestones have been achieved by the specific user and how many milestones (in the same subject) has been achieved by the comparable group of users. As well, the report can detail which lower level milestones were achieved by the user for target milestone which have not been achieved. This type of report can show how far or how close the user is when it comes to achieving desired milestones. The report can even provide reasons, culled from the database data, as to why the user failed to achieve the target milestones. As will be explained below, the report may also contain recommended activities and activity related materials for the user. Of course, these recommended activities and activity related materials may be based on the user's performance or progress. As well, these recommended activities and activity related materials can be based on the user's determined shortcomings or unachieved milestones.

The use of these above specific parameters allows for a common assessment platform to be used among different activities, applications, and games. For ease of use of these parameters across different applications and activities, it is preferred that developers of these applications use the specific parameters as outlined above. Such use would allow for consistency in the application of the parameters and in the results of data mining in the individual user performance database.

Regarding the implementation details for the two performance databases, it should be clear that various tables will need to be defined and created in the different performance databases and in the various computing devices involved in the system. The design and the implementation of these various tables are within the purview and capability of a person skilled in the art.

In one implementation, the individual user performance database may include a reference database containing a complete list of achievement milestones and sub-milestones with age and level references. Data collected each time a user uses an application is compared against these milestones and sub-milestones. If necessary, this comparison can also take into account the specific user's age. In addition to the reference database with the milestone related data, the individual user performance database also includes a user specific database containing historical data collected from the user. Every time the user uses specific activity related material on the user computing device, data is gathered on how the user performed when using the activity related material. This data can be used to determine how the user is progressing towards pre-determined achievement milestone targets. The data gathered can be stored in the individual user performance database. Each device can include a user profile which contains user achievement records based on the target milestones for that specific user. These profiles can, depending on the implementation, also be uploaded to the cumulative user performance database.

As noted above, each user computing device delivers the activity to the user with the user computing device gathering data regarding the performance of the user in the activity. The user computing device then stores the data as a database entry in the individual user performance database. The result of the activity, as well as other pertinent and relevant data, is then uploaded for storage in the cumulative user performance database. The data stored at the individual user performance database for storage can be cross-referenced with specific milestones, both lower level and upper level milestones to determine the user's progress. The data stored in the cumulative user performance database can then be retrieved to determine each user's progress relative to a comparable group of other users.

In addition to the various milestones associated with the various activities, the reference database can also include a database for recommended activities and other activity related material which can be used to address user issues. As an example, if a user's performance data indicates that the user is deficient in one area or does not seem to understand to achieve a particular milestone, the reference database contains activities or other user material which can be used by or in conjunction with the user to address the user's issues. Thus, as an example, if a user seems to be unable to count to 10, the reference database can contain activities or activity related material that covers counting to 5, counting to 7, and counting to 8. For this example, the reference database contains activities or activity related materials that can be used to check to see if the user can count to a lower number. If the user cannot count to the lower number then the user will need to learn or master these activities before he or she can proceed to counting to 10. For a simpler implementation, the reference database may have entries which, when accessed, details lower level activities that can be used to build up to the higher level activities. Other entries, each of which may be associated with different milestones, can detail other activities or activity related materials which can be used to address user issues.

In use, when a user's performance data relative to an activity is analyzed and the milestones achieved or not achieved by the user are determined, the end result of the analysis can include a reference to the reference database. As noted above, the reference database includes entries associated with different milestones. The entries associated with the milestones that the user failed to achieve for the activity can thus be accessed and the activities and activity related materials in the entries can be used by the device to automatically present these activities to the user. The device can present these materials and activities to the user as remedial activities or activity related materials which can be used to address the areas in which the user underperformed.

The reference database can also be used to determine a user's performance relative to not just which milestones are associated with the activity just completed but with all available milestones. After a user's performance data has been stored in the individual user performance database, the performance can be determined/analyzed against all or most of the milestone entries in the reference database. This step will ensure that, regardless of the user's performance relative to the milestones for the activity, the user will be awarded with milestones he or she has achieved even if the milestones do not directly related to the activity just completed. Thus, if a user fails a specific activity, the user can still be awarded milestones that he or she has achieved even if the milestones are not for that particularly activity. Similarly, if a user has overachieved or has done really well in an activity, the user may be awarded milestones that are beyond what he or she may be otherwise entitled to. As an example, doing very well in one activity may provide a user with milestones that leapfrogs or avoids other activities.

In one implementation of the invention, a home setting is contemplated. For such a home setting, the user can be a child equipped with a user computing device. The user can be assisted by a parent, tutor, relative, or similar person.

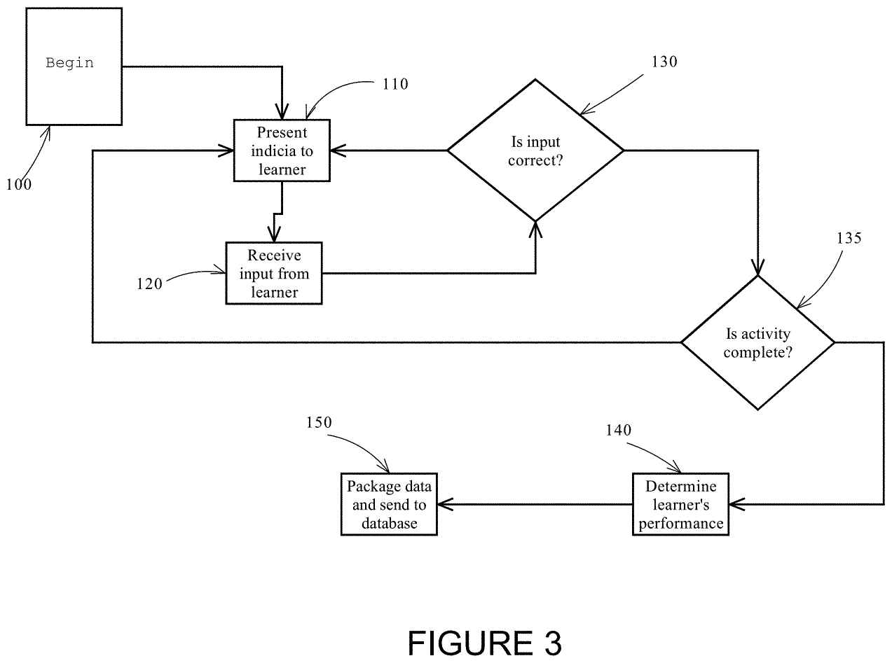

Referring to FIG. 3, a flowchart for the steps in a method according to another aspect of the invention is illustrated. Step 100 notes the beginning of the activity and the user is presented with indicia relating to the activity (step 110). This indicia can take many forms and is dependent on the activity. As an example, for the counting activity described above, the indicia can be a bug with a number of dots (which may be activated by the user) on its wing. Similarly, if the activity is that of matching young animals with their parents, the indicia includes not just the young animals but the parent animals and whatever background art may be necessary or desirable. The indicia may, of course, be configured so that the user can interact with the indicia. Thus, the user may click, drag, tap, activate or otherwise interact with at least some of the indicia to provide input for the activity.

Once the indicia has been presented to the user, the user computing device then receives input from the user by way of the user interacting with the indicia (step 120). This step continues until the user has completed input for the activity. The user's input is then determined to be correct or incorrect (step 130). If the user's input or set of inputs is incorrect, the logic of the method loops back to step 110 as the indicia is, again, presented to the user. Steps 110-130 iterate until the user completes the activity by correctly entering a suitable set of inputs that correspond to predetermined correct inputs or until a set number of iterations have been completed. Of course, as noted above, the set number of iterations may be determined by one of the parameters received from the educator computing device. It should be noted that the indicia may be changed at each iteration of steps 110-130.

Once the user has completed the activity or once the number of allowed iterations has been reached (decision 135), the performance of the user is then determined (step 140). This step may involve counting the number of iterations until the activity was completed, determining if the activity was successfully completed at all, determining how long it took to complete the activity, and determining if any errors (and how many) were made before the activity was completed. Of course, other performance measures may be used to determine the user's performance relating to the activity.

With the performance data gathered, this performance data can then be packaged as a data package or as a database entry for storage and/or transmission in either or both the individual user performance database and the cumulative user performance database. In one implementation, the data package/database entry is transmitted to the server where at least one of the databases reside (step 150).

As can be seen from the above, another aspect of the invention involves determining a user's progress towards achieving a target milestone. The method for this aspect of the invention starts with providing the user with digital content. This is done by way of the user computing device. The user then completes the digital content's activity/application and the user computing device gathers the user's performance data. The performance data is then packaged as a database entry and is uploaded to a database. Once in the database, the system can formulate performance reports based on specific parameters. Similarly, group performance data can be collated and aggregated so that it can be sent to specific devices which need such data for comparison with specific user performance data. The collated data may detail a specific target milestone and may illustrate how many users in a group have achieved that milestone based on the data in the cumulative user performance database. In addition to documenting how many users met the milestone, the collated data can provide further details as to how many users did not achieve the target milestone and which lower level milestones were achieved by these users. This is done by the server mining the cumulative user performance database for the highest milestones achieved by each user in the group and retrieving reasons for those achievements. Of course, milestones may be broken up into subject areas or categories if desired. Each device can also provide recommended activities and other materials for each of the users based on their achieved milestones. This aspect of the invention can be constructed by cross-referencing each user's user profile (including their achieved milestones) with the reference database and its entries regarding each milestone and recommended activities. Each user's unachieved milestones (i.e. milestones which were highlighted by completed activities but which were not achieved by the user) can be extracted from each user's profile and the recommended activities for these milestones can be included in the report for each user.

In another aspect, the system of the present invention can also operate to provide guidance and/or instructions for caregivers and/or instructors who are in charge of younger children.

The system can operate to provide direct instructions or guidance to these caregivers/instructors/assistants. The software in the system can direct assistants with daily and weekly activities, providing direct instructions on exactly what to do. Activities that the assistants can be guided in would fall under two categories: regular activities and assessment activities. Regular activities, for example, would ask the assistant to sing a specific song to the young child user (e.g. the song “Twinkle Twinkle Little Star”), and to repeat specific vocabulary terms (e.g. the term “star”). Assessment activities, for example, will ask assistants to not just deliver the activities with the help of the device but would also ask the assistant certain yes/no questions. For example, the system would instruct or direct the assistant to ask the child user to bring 2 pieces from the pink tower (or from any predetermined structure with a specific color). The system would then ask the assistant to ask the child which piece is bigger. In response to the question from the system, the instructor would enter a “yes” or a “no” into the device. This causes the system to tag the child's assessment that the child understands the concept of big/small.

The above variant allows for instructors or caregivers to provide services with the assistance of the system without intense training on instructional techniques.

A further variant would be a voice enabled device that dictates instructions to instructors (i.e. hands free) about activities for the user and which is able to receive instructor responses to the instructions.

For facilities with multiple child users and multiple instructors, the system can be used to monitor specific areas using onboard cameras. This variant would determine if there are enough instructors in a particular area (e.g. in a designated play area or a designated instructional area) based on how many child users are known to be in the area (i.e. how many children area as entered into the system). If the number of instructors falls below a predetermined ratio of instructors to child users, an alert to an administrative user or to an administrator would be generated.

The method steps of the invention may be embodied in sets of executable machine code stored in a variety of formats such as object code or source code. Such code is described generically herein as programming code, or a computer program for simplification. Clearly, the executable machine code may be integrated with the code of other programs, implemented as subroutines, by external program calls or by other techniques as known in the art.

The embodiments of the invention may be executed by a computer processor or similar device programmed in the manner of method steps, or may be executed by an electronic system which is provided with means for executing these steps. Similarly, an electronic memory means such computer diskettes, CD-ROMs, Random Access Memory (RAM), Read Only Memory (ROM) or similar computer software storage media known in the art, may be programmed to execute such method steps. As well, electronic signals representing these method steps may also be transmitted via a communication network.

Embodiments of the invention may be implemented in any conventional computer programming language For example, preferred embodiments may be implemented in a procedural programming language (e.g. “C”) or an object oriented language (e.g. “C++”, “java”, or “C #”). Alternative embodiments of the invention may be implemented as pre-programmed hardware elements, other related components, or as a combination of hardware and software components.

Embodiments can be implemented as a computer program product for use with a computer system. Such implementations may include a series of computer instructions fixed either on a tangible medium, such as a computer readable medium (e.g., a diskette, CD-ROM, ROM, or fixed disk) or transmittable to a computer system, via a modem or other interface device, such as a communications adapter connected to a network over a medium. The medium may be either a tangible medium (e.g., optical or electrical communications lines) or a medium implemented with wireless techniques (e.g., microwave, infrared or other transmission techniques). The series of computer instructions embodies all or part of the functionality previously described herein. Those skilled in the art should appreciate that such computer instructions can be written in a number of programming languages for use with many computer architectures or operating systems. Furthermore, such instructions may be stored in any memory device, such as semiconductor, magnetic, optical or other memory devices, and may be transmitted using any communications technology, such as optical, infrared, microwave, or other transmission technologies. It is expected that such a computer program product may be distributed as a removable medium with accompanying printed or electronic documentation (e.g., shrink wrapped software), preloaded with a computer system (e.g., on system ROM or fixed disk), or distributed from a server over the network (e.g., the Internet or World Wide Web). Of course, some embodiments of the invention may be implemented as a combination of both software (e.g., a computer program product) and hardware. Still other embodiments of the invention may be implemented as entirely hardware, or entirely software (e.g., a computer program product).

A person understanding this invention may now conceive of alternative structures and embodiments or variations of the above all of which are intended to fall within the scope of the invention as defined in the claims that follow.

We claim:

1. A system for delivering entertainment content to a user, the system comprising:
a user computing device, said user computing devices being for use said user, said user computing device determining a multimedia-based activity to be presented to said user;
an activity database storing multimedia data related to a plurality of digital entertainment activities, said data being retrieved by said user computing device to present to said user, said multimedia-based activity being presented to said user using said multimedia data retrieved from said activity database;
wherein
said user is a child of under 60 months in age.

2. The system according to claim 1, wherein said activity database is partially stored on a server remote from said user computing device.

3. The system according to claim 2 wherein said user computing device communicates with said server wirelessly.

4. The system according to claim 1, wherein said user computing device is a portable, touch enabled computing device.

5. The system according to claim 1, wherein said user computing device is equipped with a voice interface for providing audio instructions to said user for said activity.

6. The system according to claim 1, wherein said user computing device determines said multimedia-based activity using a pseudo-random number generator.

7. The system according to claim 1, wherein at least a portion of said activity database is resident on said user computing device.

8. The system according to claim 7, wherein a remainder of said activity database is resident on a server remote from said user computing device, said user computing device downloading data from said server as necessary for said multimedia-based activities to be presented to said user.

9. The system according to claim 1, wherein said user computing device uses a pattern of user activity to determine at least one activity to be presented to said user.
